(19) United States
(12) Patent Application Publication
(10) Pub. No.: US 2010/0312634 A1
(43) Pub. Date: Dec. 9, 2010

(54) COUPON CARD POINT OF SERVICE TERMINAL PROCESSING

(76) Inventor: Karen L. Cervenka, Belmont, CA (US)

Correspondence Address: Quarles & Brady LLP, TWO NORTH CENTRAL AVENUE, One Renaissance Square, PHOENIX, AZ, 85004-2391, US

(21) Appl. No.: 12/480,529

(22) Filed: Jun. 8, 2009

(51) Int. Cl. G06Q 30/00; G06Q 20/00; G06Q 40/00

(52) U.S. Cl. 705/14.38; 705/21; 705/23; 705/17; 705/41; 705/14.1; 705/14.53

(57) ABSTRACT

A method of using a point of service terminal (POS) to provide a discount on a purchase is presented. The method includes receiving a portable coupon device associated with a consumer account. Stored in the memory of the portable coupon device is an electronic coupon associated with a sponsor account and which is receivable by a merchant for a discount on a purchase, the discount being debited from the sponsor's account. Also stored in memory is the discount information, which includes identifiers for the sponsor's account, a discount amount, and the purchase eligible for the discount. The discount information is then read from the portable coupon card and a transmission is formed requesting authorization of the electronic coupon. An authorization response is received and, if it includes an approval, the discount is applied to the cost of the purchase and payment for the cost less the discount amount is accepted.

### CROSS NOTING

The case is filed concurrently with U.S. patent application Ser. No. ______, by Karen Cervenka, titled Coupon Card Generation Web Service, and with U.S. patent application Ser. No. ______, by Karen Cervenka, titled Dual Range Cellular Telephone Coupon Card Generation, and with U.S. patent application Ser. No. ______, by Karen Cervenka, titled Coupon Card Kiosk, and with U.S. patent application Ser. No. ______, by Karen Cervenka, titled Transaction Handler Merchant Reimbursement For Consumer Transaction Use Of Sponsor Discount Coupon Card, each of which is incorporated herein by reference.

### FIELD

The present invention is related to a transaction between a merchant and a consumer, is more particularly related to a discount on such a transaction, and is most particularly related to a coupon being presented by the consumer to the merchant to obtain the discount on the transaction.

### BACKGROUND

Consumers obtain paper coupons in a variety of ways. They may cut them out of a newspaper or receive them at a Point of Service (POS) terminal when making a purchase. Sometimes paper coupons are mailed to consumers by the sponsor of the coupon or other entity. Each of these distribution methods, however, are associated recurring costs. Every time a manufacturer or merchant decides to offer a paper coupon they must pay to have them printed and distributed.

Moreover, paper coupons are cumbersome and easily lost. Many consumers spend valuable time clipping the paper coupons they want from newspapers. Those who use a large number of paper coupons often spend additional time sorting the coupons into categories so that a particular coupon is easier to find. Further, customers will often receive the paper coupon some time before they intend to use it. The consumer must then store the paper coupon until they go shopping.

Additionally, consumers may not receive paper coupons for specific items they buy even though the coupons are available from a manufacturer or merchant. The consumer may not be on the mailing list to receive the coupon or it may not have been printed in the newspaper they buy. In some cases this may cause the consumer to forego purchasing a specific item in favor of a less costly alternative.

Thus, there is a need for a system that reduces the costs incurred by merchants and manufacturers in offering coupons as well as one that allows consumers to be able to quickly find and obtain the coupons they want.

### SUMMARY

In one implementation, a method of using a point of service terminal (POS) to provide a discount on a purchase is presented. The method includes receiving a portable coupon device that is associated with a consumer account. Stored in the memory of the portable coupon device is an electronic coupon associated with a sponsor account issued to a sponsor of a discount and which is receivable by a merchant for a discount on a purchase, the discount being debited from the sponsor's account. The portable coupon card additionally has the discount information stored in memory, which includes identifiers for the sponsor's account, the discount amount, and the purchase eligible for the discount. The method further includes reading the discount information from the portable coupon card and forming a transmission addressed to an acquirer requesting authorization of the electronic coupon. Next, an authorization response is received from the acquirer and, if it includes an approval of the electronic coupon, the discount is applied to the cost of the purchase and payment for the cost of the purchase less the discount amount is accepted.

In another implementation, an article of manufacture comprising a computer readable medium comprising computer readable program code disposed thereon to provide a discount on an eligible good or service to a consumer is presented. The computer readable program code includes a series of computer readable program steps to effect electronically receiving a portable coupon device that is associated with a consumer account, reading the discount information from the memory of the portable coupon device, electronically forming a transmission addressed to the acquirer requesting authorization of an electronic coupon stored in the memory of the portable coupon device, electronically receiving an authorization response, and, if it includes an approval of the electronic coupon, electronically applying the discount to the purchase and electronically accepting payment for the purchase less the discount amount. The electronic coupon is associated with a sponsor account issued to a sponsor of the discount and is receivable by a merchant for a discount on a purchase, the discount being debited from the sponsor's account.

In yet another implementation, a computer program product encoded in a computer readable medium and useable with a programmable computer processor to provide a discount on an eligible good or service to a consumer, the computer program product comprising computer readable program code which causes the programmable process to electronically receive a portable coupon device that is associated with a consumer account, electronically read the discount information from the memory of the portable coupon device, electronically form a transmission addressed to the acquirer requesting authorization of an electronic coupon stored in the memory of the portable coupon device, electronically receive an authorization response, and, if it includes an approval of the electronic coupon, electronically apply the discount to the purchase and electronically accept payment for the purchase less the discount amount. The electronic coupon is associated with a sponsor account issued to a sponsor of the discount and is receivable by a merchant for a discount on a purchase, the discount being debited from the sponsor's account.

### BRIEF DESCRIPTION OF THE DRAWINGS

Implementations of the invention will become more apparent from the detailed description set forth below when taken in conjunction with the drawings, in which like elements bear like reference numerals.

FIG. 1 illustrates an exemplary payment processing network, depicting the general environment where a coupon card may be used by a card holder to obtain a discount on a purchase;

FIG. 2 depicts a block diagram of a method of using a kiosk to obtain a coupon card associated with an electronic coupon;

FIG. 3 illustrates possible alternative implementations of the data encoding area of a coupon card;

FIG. 4 depicts the environment within FIG. 1 where a coupon card is used by a consumer to obtain a discount on a purchase.

FIG. 5 depicts a flow chart of an exemplary method used by a POS terminal to process an electronic coupon stored on a coupon card.

### DETAILED DESCRIPTION

The present discussion considers the use of a Point of Service terminal (POS) to apply an electronic coupon stored on a coupon card to the purchase of a good or service.

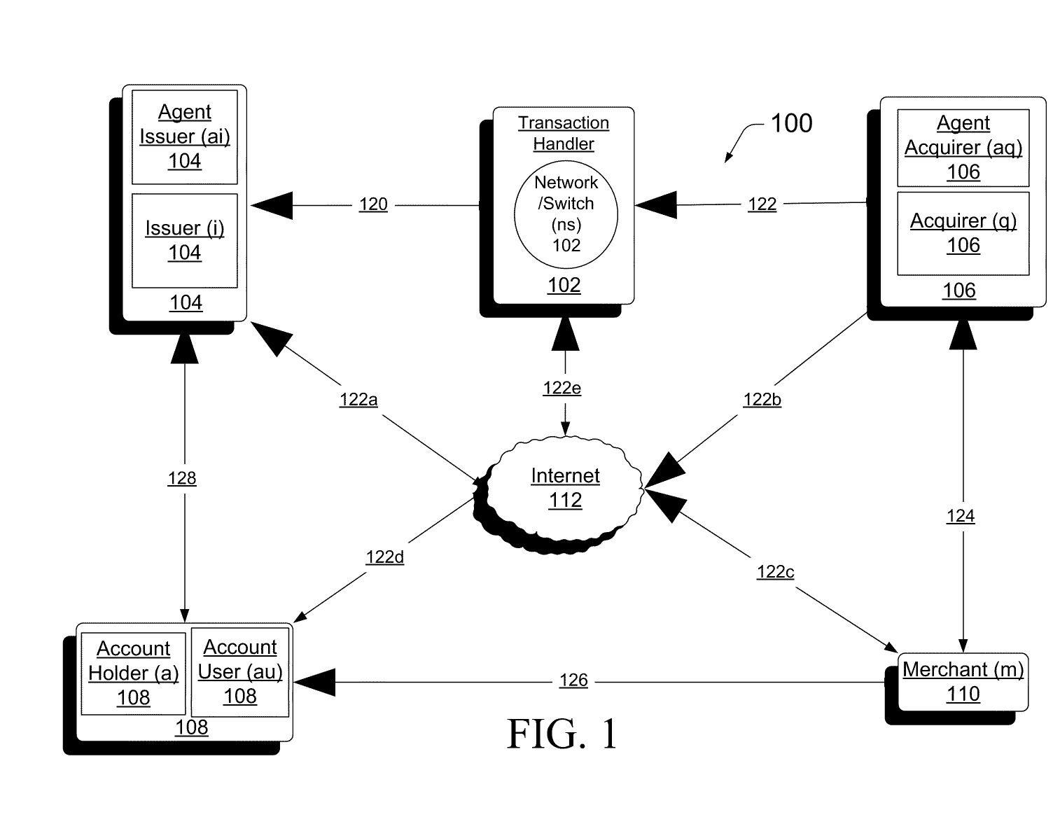

FIG. 1 illustrates an exemplary payment processing system 100, depicting a general environment in which a merchant (m) 110 can conduct a transaction for goods and/or services with an account user (au) on an account (i.e., a prepaid account) issued to an account holder (a) 108 by an issuer (i) 104, where the processes of paying and being paid for the transaction are coordinated by a transaction handler 102. The transaction includes participation from different entities that are each a component of the payment processing system 100.

Payment processing system 100 has a plurality of merchants 110 that includes merchant (1) 110 through merchant (M) 110, where M can be up to and greater than an eight digit integer.

Payment processing system 100 has a plurality of prepaid accounts 108 each of which is held by a corresponding account holder (1) 108 through account holder (A) 108, where A can be up to and greater than a ten digit integer.

Payment processing system 100 includes account user (1) 108 through account user (AU) 108, where AU can be as large as a ten digit integer or larger. Each account user (au) conducts a transaction for goods and/or services with merchant (m) 110 using an account (i.e., a prepaid account) that has been issued by an issuer (i) 104 to a corresponding account holder (a) 108. Data from the transaction on the account is collected by merchant (m) and forwarded to a corresponding acquirer (a) 106. Acquirer (a) 106 forwards the data to transaction handler 102 who facilitates payment for the transaction from the prepaid account issued by the issuer (i) 104 to account holder (a) 108.

Payment processing system 100 has a plurality of issuers 104. Each issuer (i) 104 may be assisted in processing one or more transactions by a corresponding agent issuer (ai) 104, where ‘i’ can be an integer from 1 to I, where ‘ai’ can be an integer from 1 to AI, and where I and AI can be as large as an eight digit integer or larger.

Payment processing system 100 has a plurality of acquirers 106. Each acquirer (q) 106 may be assisted in processing one or more transactions by a corresponding agent acquirer (aq) 104, where ‘q’ can be an integer from 1 to Q, where aq can be an integer from 1 to AQ, and where Q and AQ can be as large as an eight digit integer or larger.

Payment processing system 100 has a transaction handler 102 to process a plurality of transactions. The transaction handler 102 can include one or a plurality or networks and switches 102. Each network/switch (ns) 102 can be a mainframe computer in a geographic location different than each other network/switch (ns) 102, where ‘ns’ is an integer from one to NS, and where NS can be as large as a four digit integer or larger.

Dedicated communication systems 120, 122 (i.e., private communication network(s)) facilitate communication between the transaction handler 102 and each issuer (i) 104 and each acquirer (a) 106. The Internet 112, via e-mail, the World Wide Web, cellular telephony, and/or other optional public and private communications systems, can facilitate communications 122a-122e among and between each issuer (i) 104, each acquirer (a) 106, each merchant (m) 110, each account holder (a) 108, and the transaction handler 102. Alternatively and optionally, one or more dedicated communication systems 124, 126, and 128 can facilitate respective communications between each acquirer (a) 106 and each merchant (m) 110, each merchant (m) and each account holder (a) 108, and each account holder (a) 108 and each issuer (i) 104, respectively.

Each acquirer (q) 106 may be assisted in processing one or more transactions by a corresponding agent acquirer (aq) 104, where ‘q’ can be an integer from 1 to Q, where aq can be an integer from 1 to AQ, and where Q and AQ can be as large as an eight digit integer or larger.

Merchant (m) 110 may be a person or entity that sells goods and/or services. Merchant (m) 110 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder (a) 108 may be a second merchant making a purchase from another merchant (m) 110. Merchant (m) 110 may utilize at least one point-of-sale terminal (POS) that can communicate with acquirer (a) 106, transaction handler 102, or issuer (i) 104. Thus, the POS terminal is in operative communication with the payment processing system 100.

Typically, a transaction begins with account user (au) 108 presenting a portable consumer device to merchant (m) 110 to initiate an exchange for a good or service. The portable consumer device may be associated with an account (e.g., a prepaid account) of account holder (a) 108 that was issued to the account holder (a) 108 by issuer (i) 104.

The portable consumer device may be in a form factor that can be a payment card, a gift card, a smartcard, a smart media, a payroll card, a healthcare card, a wrist band, a machine readable medium containing account information, a keychain device, such as a SPEEDPASS® device commercially available from ExxonMobil Corporation, or a supermarket discount card, a cellular phone, personal digital assistant, a pager, a security card, an access card, a wireless terminal, or a transponder. The portable consumer device may include a volatile or non-volatile memory to store information such as the account number or an account holder (a) 108's name.

Merchant (m) 110 may use the POS terminal to obtain account information, such as a number of the account of the account holder (a) 108, from the portable consumer device. The portable consumer device may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer (i) 104 of the account corresponding to the portable consumer device. Alternatively, or in combination, the portable consumer device may communicate with issuer (i) 104, transaction handler 102, or acquirer (a) 106.

Issuer (i) 104 may authorize the transaction using transaction handler 102. Transaction handler 102 may also clear the transaction. Authorization includes issuer (i) 104, or transaction handler 102 on behalf of issuer (i) 104, authorizing the transaction in connection with issuer (i) 104's instructions such as through the use of business rules. The business rules could include instructions or guidelines from transaction handler 102, account holder (a) 108, merchant (km) 110, acquirer (a) 106, issuer (i) 104, a related financial institution, or combinations thereof. Transaction handler 102 may maintain a log or history of authorized transactions. Once approved, merchant (m) 110 will record the authorization, allowing account user (au) 108 to receive the good or service from merchant (m) or an agent thereof.

Merchant (m) 110 may, at discrete periods, such as the end of the day, submit a list of authorized transactions to acquirer (a) 106 or other transaction related data for processing through the payment processing system 100. Transaction handler 102 may compare the submitted authorized transaction list with its own log of authorized transactions. If a match is found, transaction handler 102 may route authorization transaction amount requests from the corresponding acquirer (a) 106 to the corresponding issuer (i) 104 involved in each transaction. Once acquirer (a) 106 receives the payment of the authorized transaction amount from issuer (i) 104, acquirer (a) 106 can forward the payment to merchant (m) 110 less any transaction costs, such as fees for the processing of the transaction. If the transaction involves a debit or pre-paid card, acquirer (a) 106 may choose not to wait for the issuer (i) 104 to forward the payment prior to paying merchant (m) 110.

There may be intermittent steps in the foregoing process, some of which may occur simultaneously. For example, acquirer (a) 106 can initiate the clearing and settling process, which can result in payment to acquirer (a) 106 for the amount of the transaction. Acquirer (a) 106 may request from transaction handler 102 that the transaction be cleared and settled. Clearing includes the exchange of financial information between the issuer (i) 104 and the acquirer (a) 106 and settlement includes the exchange of funds. Transaction handler 102 can provide services in connection with settlement of the transaction. The settlement of a transaction includes depositing an amount of the transaction settlement from a settlement house, such as a settlement bank, which transaction handler 102 typically chooses, into a clearinghouse, such as a clearing bank, that acquirer (a) 106 typically chooses. Issuer (i) 104 deposits the same from a clearinghouse, such as a clearing bank, which issuer (i) 104 typically chooses, into the settlement house. Thus, a typical transaction involves various entities to request, authorize, and fulfill processing the transaction.

Payment processing system 100 will preferably have network components suitable for scaling the number and data payload size of transactions that can be authorized, cleared and settled in both real time and batch processing. These include hardware, software, data elements, and storage network devices for the same. Examples of payment processing system 100 include those operated, at least in part, by American Express, Master Card, Discover Card, First Data Corporation, Diners Club, and Visa Inc., and agents of the foregoing.

Each network/switch (ns) 102 can include one or more data centers for processing transactions, where each transaction can include up to 100 kilobytes of data or more. The data corresponding to the transaction can include information about the types and quantities of goods and services in the transaction, information about the account holder (a) 108, the account user (au) 108, the merchant (m) 110, tax and incentive treatment(s) of the goods and services, coupons, rebates, rewards, loyalty, discounts, returns, exchanges, cash-back transactions, etc.

By way of example, network/switch (ns) 102 can include one or more mainframe computers (i.e., one or more IBM mainframe computers) for communications over systems 120, 122, one or more server farms (i.e., one or more Sun UNIX Superservers), where the mainframe computers and server farms can be in diverse geographic locations.

Each issuer (i) 104 (or agent issuer (ai) 104 thereof) and each acquirer (a) 106 (or agent acquirer (aq) 106 thereof) can use one or more router/switch (i.e., Cisco routers/switches) to communicate with each network/switch (ns) 102 via dedicated communication systems 120, 122, respectively.

Transaction handler 102 stores information about transactions processed through payment processing system 100 in data warehouses such as may be incorporated as part of the plurality of networks/switches 102. This information can be data mined. The data mining transaction research and modeling can be used for advertising, account holder and merchant loyalty incentives and rewards, fraud detection and prediction, and to develop tools to demonstrate savings and efficiencies made possible by use of the payment processing system 100 over paying and being paid by cash, checks, or other traditional payment mechanisms.

The VisaNet® system is an example component of the transaction handler 102 in the payment processing system 100. Presently, the VisaNet® system is operated in part by Visa Inc. As of 2007, the VisaNet® system Inc. was processing around 300 million transactions daily, on over 1 billion accounts used in over 170 countries. Financial instructions numbering over 16,000 connected through the VisaNet® system to around 30 million merchants. In 2007, around 81 billion transactions for about 4 trillion U.S. dollars were cleared and settled through the VisaNet® system, some of which involved a communication length of around 24,000 miles in around two (2) seconds.

In the present context, an account for the payment of future discounts on goods and services attributable to the use of electronic coupons is issued by the issuer to a third-party and credited with funds submitted by the third-party. The funds are for reimbursement of discounts on the sale of goods and services given by a merchant upon the presentation of a coupon card having at least one of the electronic coupons stored thereon.

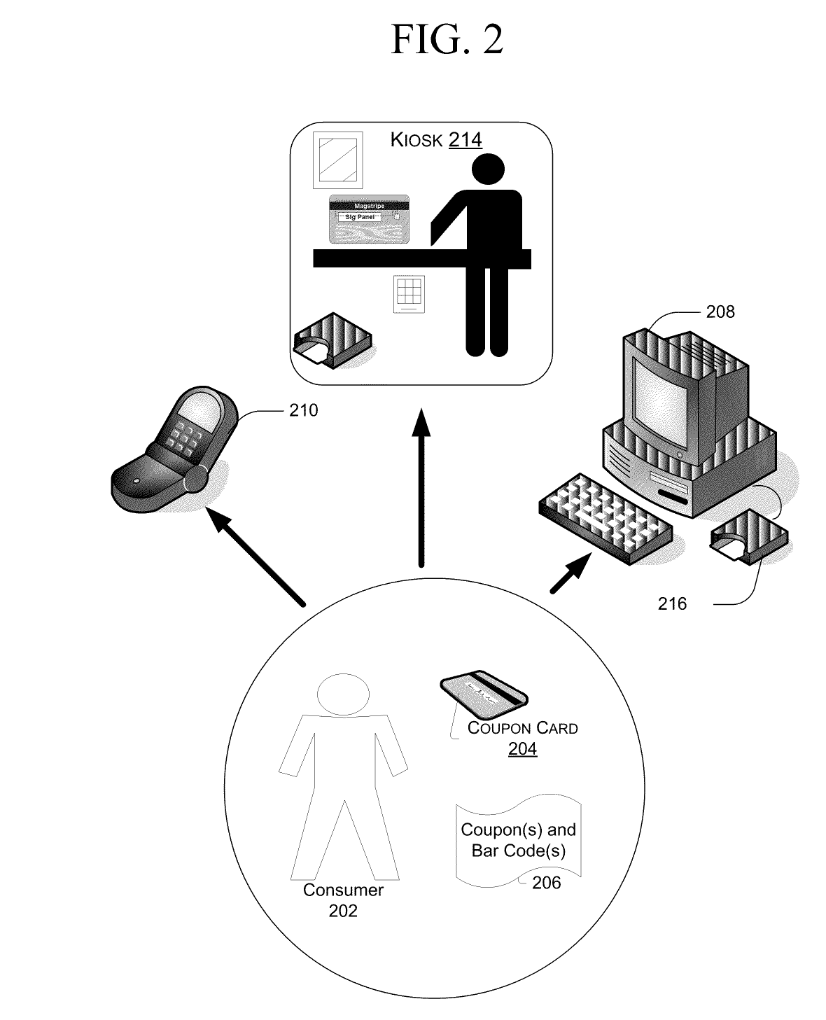

Turning now to FIG. 2, an exemplary block diagram is depicted of a consumer associating a coupon card with at least one electronic coupon that may be used to obtain a discount on the purchase of goods and services. Although the implementation is discussed in regards to a substantially planar laminated card, one skilled in the art will recognize that other forms of transaction tokens (i.e., portable consumer payment devices) could be used in the disclosed method.

In the illustrated implementation of FIG. 2, consumer 202 may associate a coupon card 204 with at least one electronic coupon using several methods. In one implementation, consumer 202 uses a web-enabled computer system 208 to connect to the /World Wide Web and browse to a website having electronic coupons available for downloading via a web service. In such an implementation, consumer 202 uses the browser to select at least one of the electronic coupons offered. Information relating to that electronic coupon is then downloaded to computer system 208, including an account identifier for the party offering the electronic coupon.

In certain implementations, the information further includes the type of product or service for which the electronic coupon is valid. By way of example and not limitation, the electronic coupon may be valid for all cleaning products made by a particular manufacturer. Alternatively, the electronic coupon may be valid for a specific dish soap made by the manufacturer.

In other implementations, the information also includes a merchant or manufacturer with which the electronic coupon is valid. In such an implementation, the electronic coupon may only be valid for use with a particular merchant or only for the purchase of a particular manufacturer's product. In other implementations, the information includes an expiration date, after which the electronic coupon is no longer valid. In yet other implementations, the information includes the number of goods or services eligible for a discount using the electronic coupon. By way of example and not limitation, the electronic coupon may be valid for discounts on up to three (3) bottles of a pain reliever. Alternatively, the electronic coupon may only be used when ten (10) car washes are purchased at the same time.

In certain implementations, the information also includes a bar code identifying the item or type of item for which the electronic coupon is valid. In such an implementation, the bar code is rendered on print-out 206 using a printer connected to computer system 208. The bar code may later be scanned by a scanner of a POS terminal to identify the item being purchased that is eligible for a discount using the electronic coupon. Print-out 206 also serves as a reminder to consumer 202 of which electronic coupons are stored on coupon card 204.

In certain implementations, print-out 206 includes advertisements. In certain implementations, print-out 206 additionally includes information regarding soon-to-be-available electronic coupons.

Once the information relating to the selected electronic coupon is downloaded to computer system 208, the account identifier is written to a coupon card 204 using card read-write device 216. In certain implementations, card read-write device 216 is attached as a peripheral to computer system 208. In certain implementations, card read-write device 216 is a memory card reader and writer. In such an implementation, coupon card 204 can be a smart card and the account identifier is stored in the memory of an embedded chip in the smart card. In certain implementations, coupon card 204 is a contact smart card having a contact area that when inserted into card read-write device 216 so as to make contact with electrical connectors capable of writing the information to the card's memory or data storage. In certain implementations, coupon card 204 is a contactless smart card in which the chip communicates wirelessly with card read-write device 216, such as through near-field communications or radio-frequency identification (RFID) induction technologies.

In certain implementations, card read-write device 216 is a magnetic card reader and writer. In such an implementation, coupon card 204 has a magnetic data stripe. The account identifier is stored on coupon card 204 when the magnetic data stripe is placed in physical contact with a read-write head of card read-write device 216.

In certain implementations, coupon card 204 includes both an embedded chip and a magnetic stripe, each of which can be written to by a peripheral device to computer 208 and/or by a POS at a merchant where the coupon card 204 is used to conduct a discount transaction. In other implementations, coupon card 204 also has the functionality of a portable consumer device, such as a credit card, debit card, prepaid card, loyalty card or other such device associated with an account of consumer 202. In such implementations, consumer 202 may use coupon card 204 to both receive a discount as well as to pay the residual balance of the discounted transaction.

In the illustrated implementation of FIG. 2, consumer 202 may also associate coupon card 204 with at least one electronic coupon using a dual range, web-enabled cellular telephone 210, where coupon card 204 is a smart card. In such implementations, consumer 202 uses cellular telephone 210 to connect to the World Wide Web, or other network, and browse to a website having electronic coupons. Upon selecting an electronic coupon, the associated information is downloaded to cellular telephone 210, including the account identifier for the third-party sponsoring the electronic coupon.

In such implementations where the information downloaded also includes a bar code, the bar code is capable of being rendered on the display of cellular telephone 210. The bar code can later be scanned by a scanner at a POS terminal to identify the type of item eligible for a discount using the electronic coupon.

Once the information relating to the selected electronic coupon is downloaded to cellular telephone 210, the account identifier associated with the sponsor of the electronic coupon is written to coupon card 204 using a moblet stored on cellular telephone 210. The moblet can include functionality for a near field communication (NFC) card read-write device capable of using NFC, or other short range wireless communication protocol, to read and write data to the memory of coupon card 204.

In the illustrated implementation of FIG. 2, consumer 202 may also associate a coupon card 204 with at least one electronic coupon using a kiosk 214. Kiosk 214 is connected to a database (not shown) capable of storing and relating information regarding the available electronic coupons. In one implementation, a third-party offering at least one electronic coupon has access to the database and may send to and receive from the database information such as the number of electronic coupons used, the number of electronic coupons remaining, or any other relevant information.

When using kiosk 214, consumer 202 is presented with a user interface displaying a plurality of electronic coupons and uses an input device to make a selection. In one implementation, consumer 202 then receives from kiosk 214 a coupon card 204. In such an implementation, kiosk 214 includes a stack of blank coupon cards which may be dispensed by the kiosk 214 to consumer 202 after being electronically enhanced with the consumer's selected coupons. In other implementations, consumer 202 obtains coupon card 204 and provides it to kiosk 214 via a card receiving device to have the selected electronic coupons stored thereon. In such implementations, consumer 202 may purchase coupon card 204 from a merchant (e.g., a pre-paid card). In other implementations, consumer 202 may receive coupon card 204 from the third-party, a merchant, or any other entity having an interest in providing electronic coupons. In yet other implementations, coupon card 204 is also a portable consumer device and is issued by an issuer to consumer 202 (i.e., the consumer's debit or credit card).

In using kiosk 214 to associate coupon card 204 with at least one electronic coupon, kiosk 214 stores information relating to the electronic coupon selected by consumer 202 on coupon card 204, including the account identifier associated with an account of the electronic coupon sponsor.

In those implementations where the selected electronic coupon is also associated with a bar code identifying the type of item for which the electronic coupon is valid, kiosk 214 additionally dispenses to the consumer 202 a print-out 206 having the bar code printed thereon. The print-out may later be scanned by a scanner at a POS terminal.

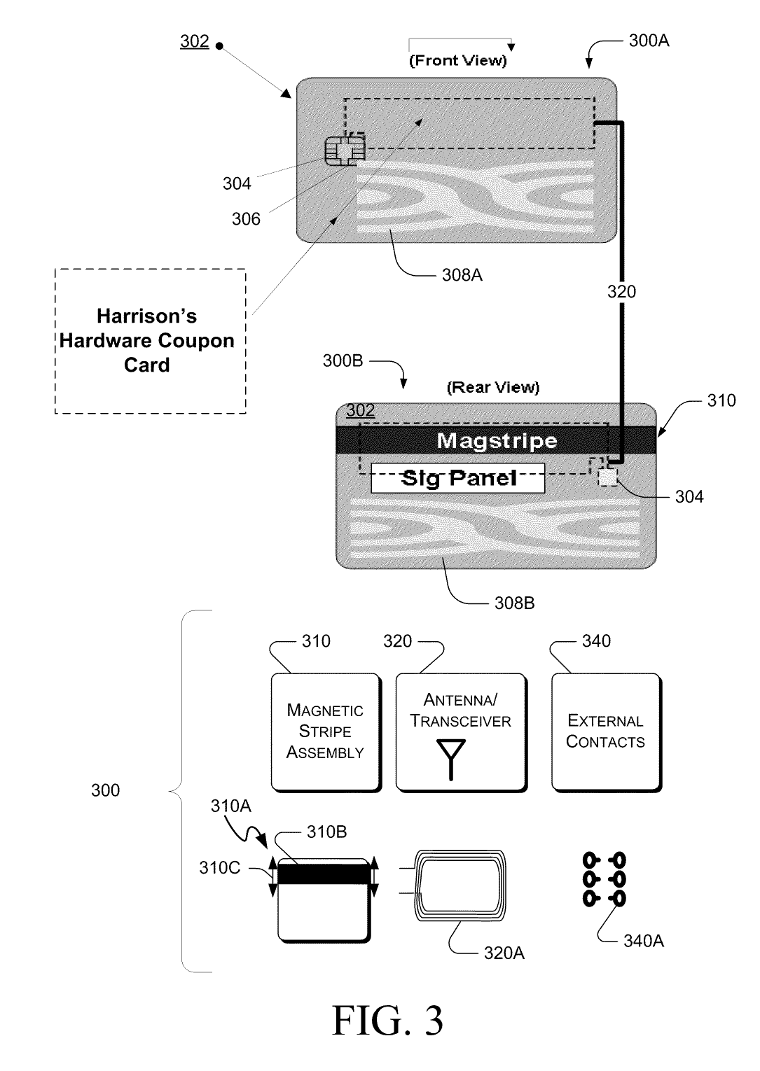

Turning to FIG. 3, both a front view 300A and a rear view 300B of an exemplary coupon card 302 are presented. Images may be displayed on both sides of coupon card 302, with image 308A on the front view 300A being either the same as or different from image 308B on the rear view 300B. In this illustration, the front view 300A also displays information about the provider of the coupon card.

FIG. 3 also shows exemplary implementations of a data encoding area of coupon card 302. The data encoding area may include an optional shielding element, which allows desired electromagnetic, optical, or radiative signals to penetrate while protecting the data encoding area from physical abuse or damage. Coupon card 302 may optionally have areas outside of the data encoding area shielded from physical abuse or otherwise acceptable forms of electromagnetic radiation. Some of the acceptable signals that are allowed to penetrate the shielding and may include, but are not limited to, signals accompanying a magnetic field, RFID signals, IrDA signals, visible light, invisible light, modulated laser, and/or modulated RF communication signals. By way of example and not limitation, a selective shielding element may comprise a clear plastic shield, conformal coatings, an opaque plastic shield, or a clear thin film, depending on the implementation of the data encoding area.

Non-limiting examples of the data encoding area are shown at reference numeral 300, and include a magnetic stripe assembly 310, an antenna and/or transceiver 320, and electrical contacts 340. Magnetic stripe assembly 310 may comprise, in the implementation shown as 310A, a reprogrammable magnetic stripe assembly 310B that accepts data and/or commands from a processor and formats and renders that data into a form on a magnetic stripe that is readable by conventional merchant magnetic stripe-reading point of sale (POS) terminals. In this manner, the processor may program a particular account for use in a transaction as a function of user input selecting the account. Alternatively, the processor may erase the magnetic stripe of assembly 310, rendering the card useless in the event of its loss or theft. In the implementation shown as 310A, magnetic stripe assembly 310B at least partially slidably moves 310C into and out of an assembly of coupon card 302 (partial view shown), allowing coupon card 302 to conduct a transaction at a point of sale terminal that includes a magnetic stripe reader.

Continuing with FIG. 3, another implementation of the data encoding area is shown as an antenna and/or transceiver 320. Antenna and/or transceiver 320 may include commonly used loop inductors such as the one shown 320A or in those shown in related ISO standards for RF-readable smart cards. With such an interface, account data may be translated, modulated and transmitted in a manner acceptable by an RF contactless merchant POS terminal, a 802.11 WiFi or WiMax network, or by a cellular or RF communications network. For instance, antenna and/or transceiver 320 may receive a wireless communication from a card read-write device, where the wireless communication carries data for a manufacturer's discount coupon account that is to be written in memory to the data encoding area 300.

Electrical contacts 340 are yet another alternative implementation of the data encoding area shown in FIG. 3. With coupon card 302 possessing physical contacts such as an array of conductive pads or shapes 340A, coupon card 302 may be placed in physical contact with a merchant POS terminals, and electrical contacts 340 may establish connectivity to the merchant's financial processing system. The processor may relay account-related information to the merchant POS terminal through the contact interface, thereby allowing coupon card 302 to be utilized with the large number of preexisting merchant POS terminals.

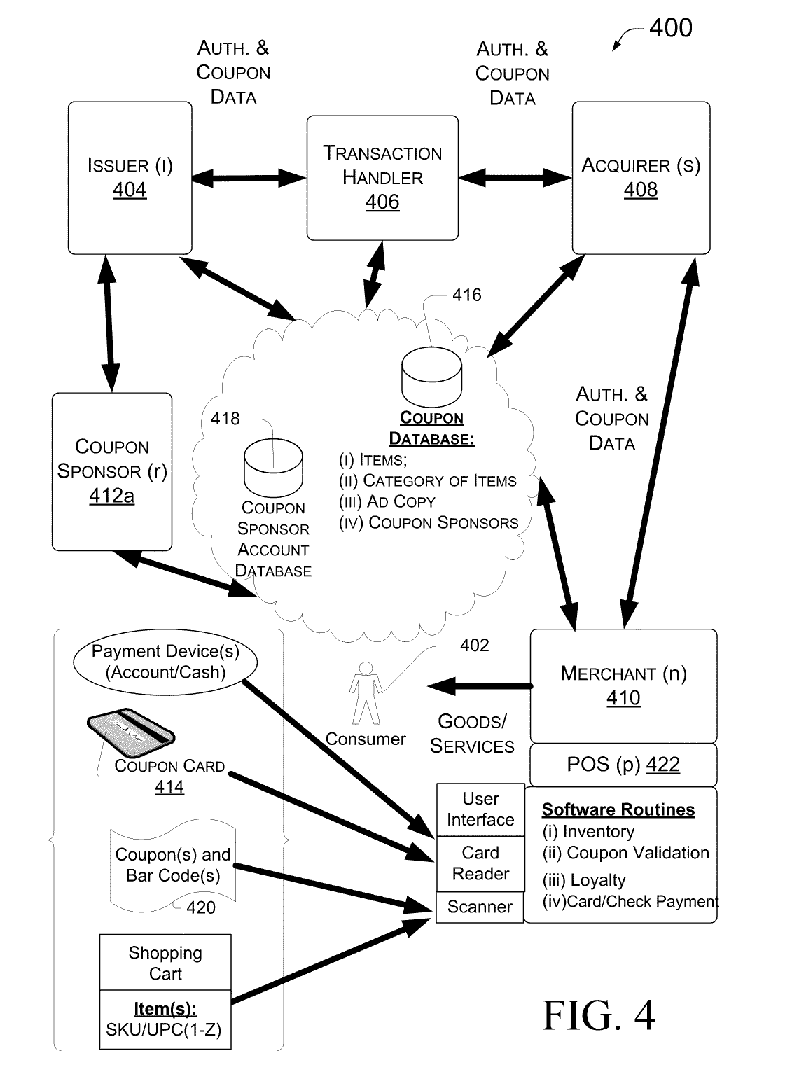

Within the exemplary payment processing system depicted in FIG. 1, FIG. 4 illustrates the general environment wherein a coupon card, such as coupon card 302 (FIG. 3) obtained by the process described in connection with FIG. 2, may be used by a consumer at a POS terminal to obtain a discount on the purchase of goods and services. To start, at POS terminal 422, consumer 402 presents to merchant 410 coupon card 414 along with the item(s) consumer 402 wishes to purchase. As will be understood by a person of ordinary skill in the art, a POS terminal is a type of computerized cash register that manages the selling process and provides a user interface for the cashier. By way of example and not limitation, POS terminals can include the ability to record and track customer orders, process credit and debit cards, connect to other systems in a network, manage inventory, implement loyalty programs, and create and print vouchers. Generally speaking, a POS terminal includes a personal computer having application-specific programs stored thereon to perform the various functions the POS terminal is capable of. Additionally, a POS terminal typically includes I/O (input/output) devices specific to particular environment in which it is being used. Further, POS terminals are often web-enabled.

In the illustrated implementation of FIG. 4, Merchant 410 uses a card reader associated with POS terminal 422 to read the information stored on coupon card 414, including the account identifier associated with electronic coupon sponsor 412. In certain implementations, coupon card 414 is read by swiping coupon card 414 through POS terminal 422. In other implementations, POS terminal 422 reads coupon card 414 using a contactless technology, such as RFID, when consumer 402 is near POS terminal 422. In yet other implementations, to be read, coupon card 414 is inserted into POS terminal 422 such that external contacts on coupon card 414 establish connectivity with POS terminal 422. In certain implementations, the card reader is physically part of POS terminal 422. In other implementations, the card reader is a peripheral device in communication with POS terminal 422.

In certain implementations, other information is also read from coupon card 414, such as, by way of example and not limitation, an expiration date, an item type, or an item quantity. In such implementations, POS terminal 422 may determine whether the electronic coupon is valid for the item being purchased. This may occur, by way of example and not limitation, by comparing the current date with the expiration data of the electronic coupon. Alternatively, POS terminal 422 may determine whether consumer 402 has purchased the quantity of the discounted item specified. POS terminal 422 may also verify whether consumer 402 has actually purchased the item or item type for which the electronic coupon is applicable.

In certain implementations, POS terminal 422 calculates the discount amount. This may occur, by way of example and not limitation, where the discount is valid for the purchase of multiple items. In such an implementation, POS terminal 422 may calculate the discount amount by multiplying the discount per item by the number of items purchased.

In one implementation, consumer 402 additionally provides print-out 420 to merchant 410. Print-out 420 has a bar code printed thereon that identifies the item eligible for a discount using the electronic coupon stored on coupon card 414. In such an implementation, the bar code is scanned with a scanner associated with POS terminal 422 to identify the item that is eligible for the discount. In certain implementations, the scanner is physically integrated into POS terminal 422. In other implementations, the scanner is a peripheral device in communication with POS terminal 422.

In certain implementations, merchant 410 may additionally enter the amount of the discount into POS terminal 422. In such implementations, the discount amount may be printed on print-out 420. In other implementations, the discount amount is read by POS terminal 422 from coupon card 414.

Upon receipt of coupon card 414, the transaction is processed similarly to the method previously described in connection with FIG. 1. Merchant 410 submits an authorization request to acquirer 408 via POS terminal 422, which includes the account identifier read from coupon card 414. In certain implementations, the authorization request may additionally include an account identifier associated with consumer 402 where consumer 402 has paid for the purchase using a credit card, debit card, or other portable consumer device.

Where acquirer 408 is not the same entity as issuer 404, acquirer 408 forwards the transaction information to a transaction handler 406, who in turn forwards it to issuer 404 to verify that the account associated with electronic coupon sponsor 412 contains sufficient funds to reimburse merchant 410 for the discount. Upon receipt of a reply from issuer 404, transaction handler 406 forwards an authorization response to acquirer 408, who forwards it to POS terminal 422 of merchant 410. Where the authorization response contains an approval of the use of the electronic coupon, consumer 402 is given a discount on the retail purchase price of the item.

In certain implementations, merchant 410 operates the POS terminal 422 to decrease the stored availability of the coupon card for future discounts according to the discount being given at the POS. In other implementations, the POS terminal 422 invalidates or deletes the electronic coupon stored on coupon card 414 using POS terminal 422 once the discount has been applied. In certain implementations, coupon card 414 may be a one-time use card. In such an implementation, merchant 410 may forgo returning coupon card 414 to consumer 402. In other implementations, coupon card 414 may be used to store subsequent electronic coupons and therefore is returned to consumer 402, for instance where the coupon card 414 also has functionality of being the consumer's debit or credit card.

In certain implementations, approval of the transaction may be more involved. In such implementations, the authorization request includes additional information, by way of example and not limitation, the item, the item type, and/or the sponsor of the electronic coupon. In one implementation, database 416 may be used to, by way of example and not limitation, verify that electronic coupon sponsor 412 has issued the electronic coupon consumer 402 is attempting to use. In such an implementation, the authorization process may include comparing the additional information provided against information stored in database 416. In other implementations, database 416 is used to keep a tally of the electronic coupons used by consumers. In such an implementation, this information may then be used by electronic coupon sponsor 412 in deciding future electronic coupons to issue or for identifying specific consumers for targeted advertising. In still other implementations, the additional information includes an identifier for the advertisement that was presented to consumer 402 with the electronic coupon being used. In such an implementation, electronic coupon sponsor 412 may charge another entity a fee for each time the advertisement is shown to consumers. Alternatively, electronic coupon sponsor 412 may change the advertisement associated with an electronic coupon after the advertisement has been presented with the electronic coupon a given number of times.

In other implementations, database 418 is used. Database 418 may contain information regarding the account issued to each coupon sponsor 412(r), where electronic coupon sponsor 412(r) is one of up to ‘R’ coupon sponsors. In such implementations, database 418 may be used to verify that the account identifier read from coupon card 414 is associated with one of the ‘R’ electronic coupon sponsors. Database 418 may additionally be used to verify that the associated account contains funds sufficient to reimburse merchant 410 for the discount applied.

When merchant 410 submits the transaction to payment processing system 400 via POS terminal 422 for clearing and settlement, the account of electronic coupon sponsor 412 is debited for the cost of the discount. Specifically, merchant 410 submits a request for payment to acquirer 408. Where acquirer 408 is not the same entity as issuer 404, acquirer 408 forwards the request to transaction handler 406. Transaction handler 406 in turn requests payment for the discount from issuer 404, where issuer 404 is the issuer of the account associated with electronic coupon sponsor 412. Issuer 404 debits the account and forward the payment to transaction handler 406 who forwards the payment to acquirer 408. Finally, acquirer 408 credits the account of merchant 410 with the amount of the discount.

As will be understood by a person of ordinary skill in the art, the process described in connection with FIG. 4 is equally applicable to the situation where a consumer uses a coupon card having multiple electronic coupons stored thereon to receive a discount on several items. In such a situation, the electronic coupons may be provided by different electronic coupon sponsors having accounts issued by different issuers. Further, it will be clear to a person of ordinary skill in the art that a coupon card may have multiple electronic coupons stored thereon that are valid at different merchants, each having a different acquirer.

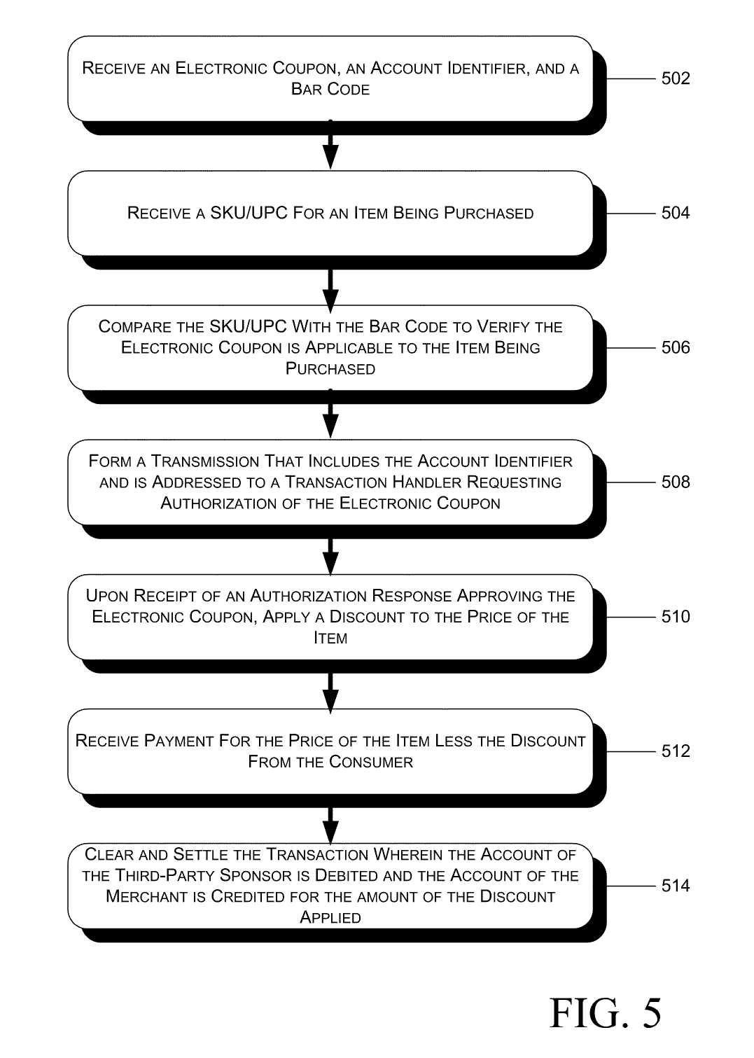

Turning now to FIG. 5, a flow chart of an exemplary method used by a POS terminal to process an electronic coupon stored on a coupon card is presented. To start, as indicated by block 502, an electronic coupon, a bar code identifying an item or type of item eligible for a discount, and an account identifier for an account associated with the coupon sponsor is received by the POS terminal. Next, the POS terminal receives the SKU/UPC (Stock-Keeping Unit/Universal Product Code) for an item that is being purchased, as indicated by block 504. As indicated by block 506, the POS terminal compares the SKU/UPC with the bar code and verifies that electronic coupon provides a discount on the item or type of item being purchased and therefore the electronic coupon should be processed.

As indicated by block 508, a transmission is formed by the POS terminal that includes the account identifier and is addressed to a transaction handler. The transmission requests authorization of the electronic coupon, wherein approval will result in a discount being applied to the purchase price of the item. Upon the receipt of an authorization response that includes such an approval, the discount is applied to the purchase price of the item, as indicated by block 510. Payment is then received from the customer for the amount of the purchase price less the discount, as indicated by block 512. Finally, as indicated by block 514, the POS terminal clears and settles the transaction, wherein the clearing and settlement process causes the account of the electronic coupon sponsor to be debited and the account of the merchant to be credited for the amount of the discount applied to the purchase price of the item.

In certain implementations, individual blocks described above may be combined, eliminated, or reordered.

In certain implementations, instructions are encoded in computer readable medium wherein those instructions are executed by a processor to perform one or more of the blocks 502, 504, 506, 508, 510, 512, and 514 recited in FIG. 5.

In yet other implementations, the invention includes instructions residing in any other computer program product, where those instructions are executed by a computer external to, or internal to, a computing system to perform one or more of the blocks 502, 504, 506, 508, 510, 512, and 514 recited in FIG. 5. In either case the instructions may be encoded in a computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like.

As an example of how the described coupon card may used, a consumer may take a coupon card with them to the grocery store, where the coupon card has at least one coupon stored thereon. At the check-out counter, the consumer provides the coupon card and a print-out of bar codes to the cashier. The cashier swipes the magnetic strip of the coupon card through the POS terminal and scans the bar codes on the print-out. The cashier then scans the SKU/UPCs for each item the consumer is purchasing. The POS terminal determines if the electronic coupons apply to any of the items by comparing the bar codes with the scanned SKU/UPCs. For example, the coupon card may contain multiple electronic coupons, one of which is for a discount on bread and is provided by the manufacturer of the bread. Another electronic coupon, that is provided by the grocery store, may be for a discount on pet food. When the POS terminal receives the SKU/UPCs for a loaf of bread and a bag of pet food, the POS terminal requests authorization to apply a discount to the items. The authorization request is, for example, received by the grocery store's acquirer.

As the acquirer is the issuer of the account associated with the grocery store, the acquirer verifies if the account has been credited with sufficient funds to pay for the discount on the pet food and sends an authorization response to the POS terminal. The request for authorization to apply a discount to the bread is forwarded by the acquirer to a transaction handler for processing. The transaction handler in turn may forward a request to the issuer of the manufacturer's account for verification that the account contains sufficient funds. Upon receiving a response, the transaction handler may send an authorization response authorizing the application of the discount to the bread.

Once the POS terminal receives the authorization responses for both coupons, the discounts are applied. The consumer may then use the coupon card to pay for the items, where the coupon card is associated with an account of the consumer's, or the consumer may use an alternative payment method.

The steps, methods, processes, and devices described in connection with the implementations disclosed herein, are made with reference to the Figures, in which like numerals represent the same or similar elements. While described in terms of the best mode, it will be appreciated by those skilled in the art that the description is intended to cover alternatives, modifications, and equivalents as may be included within the spirit and scope of the invention as defined by the appended claims and their equivalents as supported by the following disclosure and drawings. Reference throughout this specification to “one implementation,” “an implementation,” or similar language means that a particular feature, structure, or characteristic described in connection with the implementation is included in at least one implementation of the present invention. Thus, appearances of the phrases “in one implementation,” “in an implementation,” and similar language throughout this specification may, but do not necessarily, all refer to the same implementation.

The described features, structures, or characteristics of the invention may be combined in any suitable manner in one or more implementations. In the following description, numerous specific details are recited to provide a thorough understanding of implementations of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow charts included are generally set forth as logical flow chart diagrams. As such, the depicted order and labeled steps are indicative of one implementation of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. For a payment processing network that includes a plurality of merchants and consumers engaging in a plurality of transactions on a plurality of respective consumer accounts that respective issuers issue to the consumers, each said transaction involving an electronic coupon associated with a sponsor account issued by an issuer, wherein the merchant submits the transaction to an acquirer for processing by a transaction handler who requests the issuer to obtain payment for a discount applied by the merchant to the transaction from the sponsor account, and wherein the issuer forwards the payment to the transaction handler who forwards the payment to the acquirer to reimburse the merchant for the discount given on the transaction, a method of using a point of service terminal (POS) to provide a discount on a purchase to one said consumer comprising:
receiving a portable coupon device that is:
associated with one said consumer account issued by one said issuer, and acceptable as payment for a future purchase to be made on the consumer account;
and
has a memory, wherein stored on the memory is:
an electronic coupon:
being associated with a sponsor account issued to a sponsor of a discount by one said issuer; and
for being receivable by one said merchant to give the discount on a purchase, wherein the discount is to be debited from the sponsor account and credited to one said merchant account issued by another said issuer to the one said merchant to reimburse the one said merchant for the discount;
and
discount information including an identifier for:
the sponsor account;
a discount amount; and
the purchase that is eligible for the discount from the merchant and including at least one of a good and a service;
reading, using a card read/writer of the POS, the discount information from the memory of the portable coupon device;
forming a transmission, at the POS, addressed to an acquirer requesting authorization of the electronic coupon, the transmission including the sponsor account and the discount amount;
receiving an authorization response, at the POS, from the acquirer;
and
operative if the authorization response includes an approval of the electronic coupon:
applying the discount, at the POS, to a cost of the purchase; and
accepting, at the POS, a payment for the cost of the purchase less the discount amount.

2. The method of claim 1, further comprising:
receiving, at the POS, a bar code identifying the purchase; and
scanning, with a scanner of the POS, the bar code.

3. The method of claim 2, further comprising operative if the authorization response includes an approval of the electronic coupon, forming a transmission, at the POS, addressed to the acquirer requesting payment of the discount thereby starting the process of:
debiting the sponsor account for the discount amount; and
crediting the merchant account for the discount amount.

4. The method of claim 3, wherein said accepting further comprises:
reading, using the card read/writer of the POS, an identifier for the consumer account from the portable coupon device; and
forming a transmission, at the POS, addressed to the acquirer requesting payment of the cost of the purchase less the discount amount thereby starting the process of:
debiting the consumer account for the cost of the purchase less the discount amount; and
crediting the merchant account for the cost of the purchase less the discount amount.

5. The method of claim 4, wherein the portable coupon card is a smart card, the method further comprising wirelessly interrogating the smart card.

6. The method of claim 5, further comprising deleting, using the card read/writer of the POS, the electronic coupon from the portable coupon card.

7. The method of claim 6, wherein the sponsor account is issued to a member of the group comprising:
the merchant selling the purchase;
a manufacturer of the purchase;
a wholesaler of the purchase; and
a distributor of the purchase.

8. For a payment processing network that includes a plurality of merchants and consumers engaging in a plurality of transactions on a plurality of respective consumer accounts that respective issuers issue to the consumers, each said transaction involving an electronic coupon associated with a sponsor account issued by an issuer, wherein the merchant submits the transaction to an acquirer for processing by a transaction handler who requests the issuer to obtain payment for a discount applied by the merchant to the transaction from the sponsor account, and wherein the issuer forwards the payment to the transaction handler who forwards the payment to the acquirer to reimburse the merchant for the discount given on the transaction, an article of manufacture comprising a computer readable medium having computer readable program code disposed thereon which, when executed by an electronic computing apparatus, performs the method of:
electronically receiving a portable coupon device that is:
associated with one said consumer account issued by one said issuer, and acceptable as payment for a future purchase to be made on the consumer account;
and
has a memory, wherein stored on the memory is:
an electronic coupon:
being associated with a sponsor account issued to a sponsor of a discount by one said issuer; and
for being receivable by one said merchant to give the discount on a purchase, wherein the discount is to be debited from the sponsor account and credited to one said merchant account issued by another said issuer to the one said merchant to reimburse the one said merchant for the discount;
and
discount information including an identifier for:
the sponsor account;
a discount amount; and
the purchase that is eligible for the discount from the merchant and including at least one of a good and a service;
electronically reading, using a card read/writer of the POS, the discount information from the memory of the portable coupon device;
electronically forming a transmission, at the POS, addressed to an acquirer requesting authorization of the electronic coupon, the transmission including the sponsor account and the discount amount;
electronically receiving an authorization response, at the POS, from the acquirer;
and
operative if the authorization response includes an approval of the electronic coupon:
electronically applying the discount, at the POS, to a cost of the purchase; and
electronically accepting, at the POS, a payment for the cost of the purchase less the discount amount.

9. The article of manufacture of claim 8, further comprising computer readable program code which, when executed by the electronic computing apparatus, performs the method of:
electronically receiving, at the POS, a bar code identifying the purchase; and
electronically scanning, with a scanner of the POS, the bar code.

10. The article of manufacture of claim 9, further comprising computer readable program code operative if the authorization response includes an approval of the electronic coupon, which, when executed by the electronic computing apparatus, performs the method of electronically forming a transmission, at the POS, addressed to the acquirer requesting payment of the discount thereby starting the process of:
debiting the sponsor account for the discount amount; and
crediting the merchant account for the discount amount.

11. The article of manufacture of claim 10, wherein said accepting further comprises computer readable program code which, when executed by the electronic computing apparatus, performs the method of:
electronically reading, using the card read/writer of the POS, an identifier for the consumer account from the portable coupon device; and
electronically forming a transmission, at the POS, addressed to the acquirer requesting payment of the cost of the purchase less the discount amount thereby starting the process of:
electronically debiting the consumer account for the cost of the purchase less the discount amount; and
electronically crediting the merchant account for the cost of the purchase less the discount amount.

12. The article of manufacture of claim 11, wherein the portable coupon card is a smart card, the article of manufacture further comprising which, when executed by the electronic computing apparatus, performs the method of wirelessly interrogating the smart card.

13. The article of manufacture of claim 12, further c which, when executed by the electronic computing apparatus, performs the method of electronically deleting, using the card read/writer of the POS, the electronic coupon from the portable coupon card.

14. The article of manufacture of claim 13, wherein the sponsor account is issued to a member of the group comprising:
the merchant selling the purchase;
a manufacturer of the purchase;
a wholesaler of the purchase; and
a distributor of the purchase.

15. For a payment processing network that includes a plurality of merchants and consumers engaging in a plurality of transactions on a plurality of respective consumer accounts that respective issuers issue to the consumers, each said transaction involving an electronic coupon associated with a sponsor account issued by an issuer, wherein the merchant submits the transaction to an acquirer for processing by a transaction handler who requests the issuer to obtain payment for a discount applied by the merchant to the transaction from the sponsor account, and wherein the issuer forwards the payment to the transaction handler who forwards the payment to the acquirer to reimburse the merchant for the discount given on the transaction, a computer program product encoded in a computer readable medium and useable with a programmable computer processor to provide a discount on a purchase to a consumer, the computer program product comprising:
computer readable program code which causes said programmable process to electronically receive a portable coupon device that is:
associated with one said consumer account issued by one said issuer, and acceptable as payment for a future purchase to be made on the consumer account;
and
has a memory, wherein stored on the memory is:
an electronic coupon:
being associated with a sponsor account issued to a sponsor of a discount by one said issuer; and
for being receivable by one said merchant to give the discount on a purchase, wherein the discount is to be debited from the sponsor account and credited to one said merchant account issued by another said issuer to the one said merchant to reimburse the one said merchant for the discount;
and
discount information including an identifier for:
the sponsor account;
a discount amount; and
the purchase that is eligible for the discount from the merchant and including at least one of a good and a service;
computer readable program code which causes said programmable process to electronically read, using a card read/writer of the POS, the discount information from the memory of the portable coupon device;
computer readable program code which causes said programmable process to electronically form a transmission, at the POS, addressed to an acquirer requesting authorization of the electronic coupon, the transmission including the sponsor account and the discount amount;
computer readable program code which causes said programmable process to electronically receive an authorization response, at the POS, from the acquirer;
and
operative if the authorization response includes an approval of the electronic coupon:
computer readable program code which causes said programmable process to electronically apply the discount, at the POS, to a cost of the purchase; and
computer readable program code which causes said programmable process to electronically accept, at the POS, a payment for the cost of the purchase less the discount amount.

16. The computer program product of claim 15, further comprising:
computer readable program code which causes said programmable process to electronically receive, at the POS, a bar code identifying the purchase; and
computer readable program code which causes said programmable process to electronically scan, with a scanner of the POS, the bar code.

17. The computer program product of claim 16, further comprising computer readable program code operative if the authorization response includes an approval of the electronic coupon, which causes said programmable process to electronically form a transmission, at the POS, addressed to the acquirer requesting payment of the discount thereby starting the process of:
debiting the sponsor account for the discount amount; and
crediting the merchant account for the discount amount.

18. The computer program product of claim 17, wherein said accepting further comprises:
computer readable program code which causes said programmable process to electronically read, using the card read/writer of the POS, an identifier for the consumer account from the portable coupon device; and
computer readable program code which causes said programmable process to electronically form a transmission, at the POS, addressed to the acquirer requesting payment of the cost of the purchase less the discount amount thereby starting the process of:
debiting the consumer account for the cost of the purchase less the discount amount; and
crediting the merchant account for the cost of the purchase less the discount amount.

19. The computer program product of claim 18, further comprising computer readable program code which causes said programmable process to electronically delete, using the card read/writer of the POS, the electronic coupon from the portable coupon card.

20. The computer program product of claim 19, wherein the sponsor account is issued to a member of the group comprising:
the merchant selling the purchase;
a manufacturer of the purchase;
a wholesaler of the purchase; and
a distributor of the purchase.
